(19) United States
(12) Patent Application Publication
(10) Pub. No.: US 2005/0004851 A1
(43) Pub. Date: Jan. 6, 2005

(54) ReflexZPlan

(76) Inventor: Watsaka Chuangsuvanish, Bangkok (TH)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/847,485

(22) Filed: May 17, 2004

Related U.S. Application Data
(63) Continuation of application No. 09/732,531, filed on Mar. 7, 2001.

(51) Int. Cl. G06F 17/60

(52) U.S. Cl. 705/30

(57) ABSTRACT

The software comprises of the dynamic financial accounting spreadsheet; providing complete, sufficient, reconciled and correct financial report and the schools of thinking; means to interpret the business information. It provides user the capability to illustrate real, possible and potential management initiatives. It overviews business picture and focuss on details and is able to be tailor-maded upon usage requirement and preference. The dynamic financial accounting spreadsheet, the money component, works as gauges, illustrating other five business components; market, man, management, method and machine. The software groups and shows the business information in its proper place, providing user the full capacity and capability to perform intuitions and initiatives correctly. It enables user to balance, harmonize and synergize all business components, resulting in slimming and healthy business and being positioned and performing properly. The software is the management tool to help react to the global flux correctly and fast.

### CROSS-REFERENCE TO RELATED APPLICATION

This application is a Continuation of U.S. Patent Application No. 09/732,531, filed Mar. 7, 2001, which is incorporated by reference herein in its entirety.

### BACKGROUND

Business in this era is more complex than ever. Pools of information are required to be grouped and weighed properly. Changes are increasingly rapid and larger in numbers and magnitudes.

The reactions to this flux must be correct and fast.

The business theme is not as simple as buying and selling anymore. The present theme demands 3-dimension maneuvering.

Like flying, the business plan should contain future trend forecast, self preparation, business setting, route and alternatives, performance and limitations and the true reasons of the business. In maneuvering in these kinds of situations, our brains possess the intuitions and initiatives, the processes of comprehension, judgement and decision. Still, it has limited capability and capacity.

The functions of brain and mind fluctuate upon physical condition, rhythm of the day, loads of work, kinds of involved matter, emotional status and the environments. These factors cause the process to be, sometimes, instable and inaccurate.

We requires additional tools to help us function properly. The additional tools are required to put the information into its proper place, illustrate it correctly in the easiest way to be comprehended, and record all processes into tangible data.

Along with the proper information, we require the schools of thinking to interpret these data into the overviewing business pictures and focusing details for strategic management activities in daily practice.

The old tools are too small in capacity, too slow in processing and incompetence in capability.

Like a pilot in the cockpit, we require more advanced tools to help tackle this complex situation.

### SUMMARY OF THE INVENTION

RFZP is a mean to help you maneuver business properly.

It comprises of two parts,
a) the dynamic financial accounting spreadsheet; mean to group and show the information correctly in its proper place and
b) the schools of thinking; means to interpret the information.

a) The dynamic financial accounting spreadsheet, DFAS, provides complete, sufficient, reconciled and correct accounting figures.

Business nature comprises of 6 components, Market, Money, Man, Management, Method and Machine. DFAS is the Money business component. It works as gauges, showing the business components via the figures in the financial report; the balance sheet, the income statement and the cash flow statement. The other five business components; Market, Man, Management, Method and Machine, appear through the combination of accounting elements and figures in this spreadsheet.

To the data input unit, attaching to DFAS, we put in the architectures of business, business settings, i.e. daily sale, monthly working days, price and profit margin, office rental and decoration expenses, manager and clerk salary, bank loan and owner equity. The result, the financial report, appears in DFAS. Thus, DFAS illustrates the business structure and performance in the real market situation.

DFAS dynamic property also simulates the result of business settings instantly. Based on various business settings, different business structures, performances, activities and daily schedules can be read through this process.

Management initiative is the business solution that answer all questions to every management dimensions. DFAS provides the outcomes that answer all business component dimensions in financial figures. These are the available management initiatives, based on the financial support and responsibility.

b) The schools of thinking interpret the financial and accounting data into business components, structure and performance, providing software applications.

The software comprises of 5 concepts and 9 applications in school of thinking.

The Concepts

i) Composing the business into life requires 6 components, 6 M's, starting from Market, Money, Man, Management, Method and Machine, respectively.

ii) Designing one business component affects the other fives. Naturally, all 6 M's are compiled into the cubical interrelationship. Within this interrelationship, any management activity would affect all 6 M components simultaneously. Thus, every management activity is naturally Strategic Management Initiatives, SMI'S, itself.

iii) As the most crucial essence of the business is the financial aspect, the bottom line, the financial figures are the key figures. DFAS provides correct reconciled accounting figures and all management initiatives that possess financial support and responsibility.

iv) Management initiative can be realistic, possible and potential in the real situation, only if it possesses financial support and responsibility. The financial accounting report would show correct figures only if it is reconciled. Every real, possible and potential business plan must possess these two qualities, the correct financial and accounting figures and the financial support and responsibility. Therefore, this software is essential to make real, possible and potential business plans.

v) Working on the best computer in the world, the human brain, we naturally possess the intuition and initiative process, called the common sense. This software is the tool to help you clarify the overviewing picture and focusing details along with your common sense. It would show you how business components interrelate. The software would help you maneuver your business better.

### THE APPLICATIONS

1) This software would help clarify these interrelationships both in the overview picture and focusing details. You would be able to answer more precisely to the questions like, “What would the business look like?” and “How much more money would I need to be prepared for the coming market expansion?”.

2) Possessing the tangible capability to overview and focus all 6 dimensions of 6 M's, this software enables us to balance, harmonize and synergise all business components.

3) DFAS works as gauges to monitor business performance. Financial report shows performance of all business components in financial figures. In smaller scale, considering each unit in the business structure as a profit center, DFAS provides means to show all every performance levels.

Besides working as gauges, DFAS also possesses the capability to show the limitations of business components in every business settings. By entering different values to all variables in business setting details, i.e. price and profit margin, you would possess the possible potential range of business performance. The impossible results show the limitations caused by each business components.

4) Knowing the competitive edge, limitations of your business settings and available management initiatives, prior to your business moves and maneuvering, provides you with a safety margin and the best in hand advice.

By this mean, you would be able to construct the most proper business flight plan, namely the business route and daily schedule.

5) The business route and the daily schedule give assistance to brain computing function. Like mental arithmetic calculation, brain which has limited capacity and capability has to memorize and compute. The business route and the daily schedule work as the Read Only Memory, ROM, saving your brain memorizing capacity. This provides you full brain computing capacity, the Random Access Memory, RAM, upon confronting the coming situation.

The business route and the daily schedule, which is based on all possible potential range of business performance with safety margin, also helps save your gut feeling, yielding the best psychological condition upon confronting the coming situation.

Possessing full brain capacity and best psychological condition, you are at peak personal performance. At peak personal performance, you make minimum mistakes and the best moves.

6) With these capabilities and capacity, you would be able to overview the business picture clearly and focus each detail precisely. This helps you set your business properly.

Like every well-trained athlete, properly set business is healthy. It is profitable, slim in the structure, balanced in component, strong in the market position, potential in the future and active at high performance level with safety margin. The business is effective and efficient.

Setting business properly slims your business component structure, your daily schedule and personal performance capacity.

You would gain an additional schedule clearance, personal performance increment and budget. With these additional benefits, you would be able to upgrade your intuitive and initiative performance.

Any management initiative produced would maintain and enforce your competitiveness, enlarge your limitations, enable you to monitor and probe for the environment and market trends and upgrade your personal performance.

7) With the properly managed business, you would reach the best daily schedule and lifestyle available. This would best answer the true reason of the business, your happiness.

When you are happy with your business, you can do it best. This is the circle of prosperity and business would be based upon happiness of both sides, the customer and business owner.

With the properly managed business, the good margin of living and the happiness in your life, you would be able to come to spiritual purification, the true meaning of living.

8) The most precious asset is time. It is limited, intangible, unstorable and always depleting by itself. You have to utilize it one way or another. Time never stops and the interest runs with it.

Maneuvering business properly provides you the shortest route. It reduces the Redo's. Mistakes cost your three times the work, the mistake, the correction and the work. With properly maneuvering, you do your work once.

With the shortest route, you would be in the leading position in the competing market.

Time is an one-way trip and opportunity comes only once in a while. With your leading position and peak performance, you would have better chances to grab and utilize the incoming opportunities.

9) With healthy and properly maneuvering business, your reactions to the global flux would be fast and correct.

By using DFAS as the management gauges, you would be able to navigate and conduct your business properly. Using your knowledge, experience and information, together with this school of thinking and DFAS, your business flight would be safe and sound.

1. A means to help maneuver business properly, comprising:
a) a mean to group and show business information; and
b) a mean to interpret business information, said mean to group and show business information comprising:
i) a dynamic financial accounting spreadsheet, and
ii) a data input unit;
said mean to interpret business information comprising:
i) a school of thinking, said school of thinking comprising:
i.i) a group of concepts, and
i.ii) a group of methods of application.

2. An apparatus to help maneuver business properly, the apparatus comprising:
a dynamic financial accounting spreadsheet, the dynamic financial accounting spreadsheet displaying financial and accounting figures in response to input business settings; and
a means for interpreting business information, the means for interpreting business information interprets the financial and accounting figures into business components and displays the interpreted financial and accounting figures in the dynamic financial accounting spreadsheet.

3. The apparatus of claim 2, wherein the business components are associated with Market, Money, Man, Management, Method and Machine.

4. The apparatus of claim 2, wherein the financial and accounting figures are displayed in a financial report including: an income statement, a balance sheet, and a cash flow statement.

5. A method to help maneuver business properly, the method comprising:
updating a dynamic financial accounting spreadsheet in response to input business settings;
interpreting the financial and accounting figures into business components; and
displaying the interpreted financial and accounting figures in the dynamic financial accounting spreadsheet.

6. The method of claim 5, wherein the business components are associated with Market, Money, Man, Management, Method and Machine.

7. The apparatus of claim 7, wherein the financial and accounting figures are displayed in a financial report including: an income statement, a balance sheet, and a cash flow statement.
